(19) United States
(12) Patent Application Publication
(10) Pub. No.: US 2026/0347713 A1
(43) Pub. Date: Nov. 5, 2026

(54) UPGRADING LIQUEFIED WASTE PLASTICS

(71) Applicant: NESTE OY J, Espoo (FI)

(72) Inventors: Antti KURKIJÄRVI, Porvoo (FI); Marjut AHO, Porvoo (FI); Jarmo KELA, Porvoo (FI); Mika T KETTUNEN, Porvoo (FI); Martti RUSKOAHO, Porvoo (FI)

(73) Assignee: NESTE OY J, Espoo (FI)

(21) Appl. No.: 19/487,256

(22) PCT Filed: May 23, 2024
(86) PCT No.: PCT/FI2024/050264

§ 371 Date: Nov. 24, 2025

(30) Foreign Application Priority Data
May 31, 2023 (FI) 20235610

(51) Int. Cl. C10G 65/12; C10G 1/00; C10G 19/02; C10G 45/02; C10G 45/38; C10G 47/24; C10G 67/10

(52) U.S. Cl. CPC C10G 65/12; C10G 1/002; C10G 19/02; C10G 45/02; C10G 45/38; C10G 47/24; C10G 67/10; C10G 2300/1003; C10G 2300/20; C10G 2400/02; C10G 2400/08

(57) ABSTRACT

The disclosure relates to a method for upgrading liquefied waste plastic (LWP) and includes providing a LWP-based feedstock, subjecting the LWP-based feedstock to mild hydrotreatment in a presence of hydrogen and a hydrogenation catalyst to provide a hydrotreated LWP, providing the hydrotreated LWP as a first hydrocracking feed, and/or fractionating the hydrotreated LWP to obtain at least a naphtha fraction and a heavy fraction, providing the heavy fraction, as a second hydrocracking feed, hydrocracking the first hydrocracking feed and/or the second hydrocracking feed in a moving-catalyst type reactor system in a presence of hydrogen and a hydrogenation catalyst to obtain a hydrocracked product, and fractionating the hydrocracked product to obtain at least a distillate fraction and a residue fraction.

### TECHNICAL FIELD The present invention relates to a method of upgrading liquefied waste plastics (LWP), to a hydrocarbon fraction obtained from such a method.

### TECHNICAL BACKGROUND

Methods for processing waste plastics into raw material for new plastics and chemicals have gained increasing interest in recent years as an option for improving sustainability of existing production processes or for creating new processes and products.

For example, FI 129981 B discloses a method of steam cracking a blend of LWP and a highly paraffinic material to provide a product mixture rich in ethylene and propylene. FI 128848 B discloses a method comprising pre-treating and subsequently hydrotreating LWP to provide a steam cracker feed.

WO 2007/126120 A1 discloses a method which comprises dissolving waste plastics in a solvent which is poorly soluble in water, followed by hydrocracking the plastic solution after water rinsing. This document thus employs dissolved waste plastics as a hydrocracking feed rather than employing liquefied waste plastics.

### BRIEF DESCRIPTION OF THE INVENTION

The present invention focusses on an improved integrated method for upgrading LWP by combining specific pre-treatment and hydrocracking so as to make maximum use of the LWP material while allowing maximum flexibility regarding the product distribution in accordance with market needs.

In brief, the present invention relates to one or more of the following items:
1. A method for upgrading liquefied waste plastic (LWP), the method comprising:
   (a) providing a liquefied waste plastic-based feedstock (LWP-based feedstock),
   (b) subjecting the LWP-based feedstock to mild hydrotreatment in the presence of hydrogen and a hydrogenation catalyst to provide a hydrotreated LWP,
   (c1) providing the hydrotreated LWP, after optional blending with a first hydrocarbon feed, as a first hydrocracking feed, and/or
   (c2) fractionating the hydrotreated LWP to obtain at least a naphtha fraction and a heavy fraction, and providing the heavy fraction, after optional blending with a second hydrocarbon feed, as a second hydrocracking feed,
   (d) hydrocracking the first hydrocracking feed and/or the second hydrocracking feed in a moving-catalyst type reactor system in the presence of hydrogen and a hydrogenation catalyst to obtain a hydrocracked product, and
   (e) fractionating the hydrocracked product to obtain at least a distillate fraction and a residue fraction.
2. The method according to item 1, wherein the method comprises at least step (c1).
3. The method according to item 1 or 2, wherein the method comprises at least step (c2).
4. The method according to any one of the preceding items, wherein the method further comprises splitting up the hydrotreated LWP into at least two volumes and forwarding a first volume to step (c1) and a second volume to step (c2).
5. The method according to any one of the preceding items, wherein the first hydrocracking feed and the second hydrocracking feed are both subjected to step (d) together.
6. The method according to any one of the preceding items, wherein the first hydrocarbon feed is the same as the second hydrocarbon feed, and is blended with in the first hydrocracking feed and/or the second hydrocracking feed.
7. The method according to any one of the preceding items, wherein the first hydrocarbon feed is at least one selected from the group consisting of
   a crude oil-derived feedstock comprising at least one crude oil-fraction, wherein the crude oil fraction is selected from vacuum gas oil (VGO) fraction, gas oil (GO) fraction, heavy gas oil (HGO) fraction, kerosene fraction, light gas oil fraction, atmospheric residue (AR) fraction, vacuum residue (VR) fraction and deasphalted oil (DAO) fraction,
   a crude LWP and/or a fraction thereof,
   a bio-based hydrocarbon feed derived from fat(s) or oil(s) or fatty acid(s), or derivatives of fat(s), oil(s) or fatty acid(s),
   lignocellulose-based hydrocarbon(s),
   used lubricating oil(s),
   Fischer Tropsch hydrocarbon(s).
8. The method according to any one of the preceding items, wherein the second hydrocarbon feed is at least one selected from the group consisting of
   a crude oil-derived feedstock comprising at least one crude oil-fraction, wherein the crude oil fraction is selected from vacuum gas oil (VGO) fraction, gas oil (GO) fraction, heavy gas oil (HGO) fraction, kerosene fraction, light gas oil fraction, atmospheric residue (AR) fraction, vacuum residue (VR) fraction and deasphalted oil (DAO) fraction,
   a crude LWP and/or a fraction thereof,
   a bio-based hydrocarbon feed derived from fat(s) or oil(s) or fatty acid(s), or derivatives of fat(s), oil(s) or fatty acid(s),
   lignocellulose-based hydrocarbon(s),
   used lubricating oil(s),
   Fischer Tropsch hydrocarbon(s).
9. The method according to any one of the preceding items, wherein the method further comprises a pre-processing step before step (b).
10. The method according to item 9, wherein the pre-processing step comprises at least aqueous alkaline heat treatment (HT processing) of the LWP-based feedstock.
11. The method according to item 10, wherein the HT processing is carried out at a temperature in the range of 150 °C to 450 °C, preferably 200 °C to 450 °C.
12. The method according to any one of the preceding items, wherein the HT processing is carried out at a temperature of 150 °C or more, preferably 190 °C or more, 200 °C or more, 210 °C or more, 220 °C or more, 240 °C or more, or 260 °C or more.
13. The method according to any one of the preceding items, wherein HT processing is carried out at a temperature of 450 °C or less, preferably 400 °C or less, 350 °C or less, 320 °C or less, or 300 °C or less.
14. The method according to any one of the preceding items, wherein HT processing is carried out at a temperature in the range of 200 °C to 350 °C, preferably 220 °C to 330 °C, 240 °C to 320 °C, or 260 °C to 300 °C.
15. The method according to any one of items 9 to 14, wherein pre-processing comprises purifying the LWP-based feedstock to produce a purified LWP-based feedstock and then fractionating the purified LWP-based feedstock to produce at least one distillate fraction and a purified residue fraction, and forwarding the purified residue fraction to step (b) as the LWP-based feedstock.
16. The method according to item 9, wherein pre-processing comprises fractionating the LWP-based feedstock to produce at least one distillate fraction and a residue fraction.
17. The method according to any one of the preceding items, wherein the method further comprises subjecting the naphtha fraction obtained from step (c2) to hydrotreatment.
18. The method according to item 17, wherein the hydrotreatment (of the naphtha fraction) is performed with a fixed bed reactor or a moving-catalyst type reactor.
19. The method according to any one of the preceding items, wherein at least one of a naphtha fraction and a diesel fraction is obtained from fractionating the hydrocracked product in step (e).
20. The method according to any one of the preceding items, wherein at least a naphtha fraction and a diesel fraction are obtained from fractionating the hydrocracked product in step (e).
21. The method according to item 19 or 20, wherein at least one of a gasoline fraction, a heavy fuel oil fraction, and a jet fuel fraction is further obtained from fractionating the hydrocracked product in step (e).
22. The method according to any one of the preceding items, wherein the method further comprises a finishing step.
23. The method according to item 22, wherein the finishing step comprises subjecting at least a fraction of the hydrocracked product to at least one of an isomerisation step and/or a mild hydrocracking step and/or a polishing hydrotreatment step.
24. The method according to item 22 or 23, wherein the finishing step comprises subjecting at least a fraction of the hydrocracked product to at least a polishing hydrotreatment step, and the polishing hydrotreatment step is carried out at a temperature in the range of from 300 °C to 450 °C.
25. The method according to any one of items 22 to 24, wherein the finishing step comprises subjecting at least a fraction of the hydrocracked product to at least a polishing hydrotreatment step, and the polishing hydrotreatment step is carried out at a pressure in the range of from 20 bar to 80 bar, preferably 40-60 bar.
26. The method according to any one of items 22 to 25, wherein the finishing step comprises subjecting at least a fraction of the hydrocracked product to at least a polishing hydrotreatment step, and the polishing hydrotreatment step is carried out in a fixed bed reactor.
27. The method according to item 22, wherein the finishing step comprises subjecting at least a fraction of the hydrocracked product to at least a mild hydrocracking step, and the mild hydrocracking step is carried out at a temperature in the range of from 300 °C to 500 °C.
28. The method according to item 22 or 27, wherein the finishing step comprises subjecting at least a fraction of the hydrocracked product to at least a mild hydrocracking step, and the mild hydrocracking step is carried out at a pressure in the range of from 125 bar to 200 bar.
29. The method according to item 22, 27 or 28, wherein the finishing step comprises subjecting at least a fraction of the hydrocracked product to at least a mild hydrocracking step, and the mild hydrocracking step is carried out in a fixed bed reactor.
30. The method according to any one of the preceding items, wherein the step (c2) provides a distillate fraction comprising components boiling at 180 °C or above as the heavy fraction.
31. The method according to any one of the preceding items, wherein the total feed to the hydrocracker contains at least 0.5 wt.-%, preferably at least 1.0 wt.-% or at least 2.0 wt.-% of the hydrotreated LWP.
32. The method according to any one of the preceding items, wherein the total feed to the hydrocracker contains at least 0.5 wt.-%, preferably at least 1.0 wt.-% or at least 2.0 wt.-% of the heavy fraction.
33. The method according to any one of the preceding items, wherein the moving-catalyst type reactor system is a moving bed reactor system, a fluidised bed reactor system, an ebullated bed reactor system or a slurry reactor system.
34. The method according to any one of the preceding items, wherein the temperature in hydrocracking step (d) is in the range of from 300 °C to 500 °C, preferably from 300 °C to 450 °C.
35. The method according to any one of the preceding items, wherein the pressure in hydrocracking step (d) is in the range of from 125 bar to 200 bar.
36. The method according to any one of the preceding items, wherein the hydrocracking step (d) is carried out in the presence of a heterogeneous catalyst.
37. The method according to any one of the preceding items, wherein the catalyst in the hydrocracking step (d) is a supported catalyst.
38. The method according to any one of the preceding items, wherein the catalyst in the hydrocracking step (d) is a supported catalyst, and the support comprises alumina and/or silica.
39. The method according to any one of the preceding items, wherein the catalyst in the hydrocracking step (d) comprises at least one component selected from IUPAC group 6, 8 or 10 of the Periodic Table of Elements.
40. The method according to any one of the preceding items, wherein the catalyst in the hydrocracking step (d) is a supported catalyst and comprises at least Mo and at least one further transition metal on a support, such as a supported NiMo catalyst or a supported CoMo catalyst, wherein the support preferably comprises alumina and/or silica.
41. The method according to any one of the preceding items, wherein the catalyst in the hydrocracking step (d) is a supported CoMo catalyst and the support comprises alumina (CoMo/Al₂O₃) and/or the catalyst is a supported NiMo catalyst and the support comprises alumina (NiMo/Al₂O₃).
42. The method according to any one of the preceding items, wherein the catalyst in the hydrocracking step (d) is a supported NiMo catalyst and the support comprises alumina (NiMo/Al₂O3).
43. The method according to any one of the preceding items, wherein the mild hydrotreatment (b) is carried out in the presence of a heterogeneous catalyst.
44. The method according to any one of the preceding items, wherein the mild hydrotreatment (b) is carried out in a fixed bed reactor system.
45. The method according to any one of the preceding items, wherein the mild hydrotreatment (b) is carried out at a temperature in the range of from 100 °C to 350 °C, preferably 170 °C to 340 °C.
46. The method according to any one of the preceding items, wherein the catalyst in the mild hydrotreatment (b) is a supported catalyst.
47. The method according to any one of the preceding items, wherein the catalyst in the mild hydrotreatment (b) is a supported catalyst, and the support comprises alumina and/or silica.
48. The method according to any one of the preceding items, wherein the catalyst in the mild hydrotreatment (b) comprises at least one component selected from IUPAC group 6, 8 or 10 of the Periodic Table of Elements.
49. The method according to any one of the preceding items, wherein the catalyst in the mild hydrotreatment (b) is a supported catalyst and comprises at least Mo and at least one further transition metal on a support, such as a supported NiMo catalyst or a supported CoMo catalyst, wherein the support preferably comprises alumina and/or silica.
50. The method according to any one of the preceding items, wherein the catalyst in the mild hydrotreatment (b) is a supported CoMo catalyst and the support comprises alumina (CoMo/Al₂O₃) and/or the catalyst is a supported NiMo catalyst and the support comprises alumina (NiMo/Al₂O₃).
51. The method according to any one of the preceding items, wherein the mild hydrotreatment (b) is repeated before forwarding the hydrotreated LWP to step (c1) and/or (c2).
52. The method according to any one of the preceding items, wherein the total fresh feed of the mild hydrotreatment (b) contains at least 50 wt.-% LWP-based feedstock, such as 50-100 wt.-%, or at least 60 wt.-%, at least 70 wt.-%, at least 80 wt.-%, at least 90 wt.-%, at least 95 wt.-%, or at least 99 wt.-% LWP-based feedstock.
53. The method according to any one of the preceding items, wherein the mild hydrotreatment (b) is performed under the following conditions:
   a H₂ to oil ratio in the range of 200 to 450Nm³/stdm³, preferably 220 to 400Nm³/stdm³;
   a LHSV (liquid hourly space velocity) in the range of 0.1 to 2.0 h⁻¹, preferably 0.2 to 0.5 h⁻¹;
   a temperature in the range of 100-350 °C, preferably 170-250 °C.
54. The method according to any one of the preceding items, wherein hydrogen is being mixed with the LWP-based feedstock before carrying out the mild hydrotreatment (b).
55. The method according to any one of the preceding items, wherein the mild hydrotreatment(b) includes a stage where a part of the hydrotreated LWP formed in the mild hydrotreatment (b) is recycled back to the mild hydrotreatment (b).
56. The method according to any one of the preceding items, wherein the LWP forming the LWP-based feedstock is derived from liquefaction of polymer waste having an oxygen content of 15 wt.-% or less, preferably 10 wt.-% or less, more preferably 5 wt.-% or less, of the total weight of the polymer waste.
57. The method according to any one of the preceding items, wherein the content of diolefins in the hydrotreated LWP is 0.30 wt.-% or lower, preferably 0.25 wt.-% or lower, 0.20 wt.-% or lower, 0.15 wt.-% or lower, or 0.10 wt. % or lower.
58. An upgraded hydrocarbon fraction being obtainable by the method according to any one of the preceding items.

### General Descriptions and Definitions

In the present invention, liquefied waste plastics, also referred to as LWP, means a product effluent from liquefaction process comprising at least depolymerising waste plastics. LWP is thus a material which is obtainable by depolymerizing waste plastics. LWP may also be referred to as polymer waste-based oil, pyrolysis oil, depolymerized polymer waste or as liquefied polymer waste.

The waste plastics may be derived from any source, such as (collected) post-consumer plastics, (collected) industrial plastics or (collected) end-life-tires (ELT). In particular, the term waste plastics refers to an organic polymer material which is no longer fit for its use or which has been disposed of for any other reason. Waste plastics may more specifically refer to end-life tires, collected consumer plastics (consumer plastics referring to any organic polymer material in consumer goods, even if not having “plastic” properties as such), collected industrial or commercial polymer (plastic) waste. In the sense of the present invention, the term waste plastics or “polymer” in general does not encompass purely inorganic materials (which are otherwise sometimes referred to as inorganic polymers). Polymers in the waste plastics may be of natural and/or synthetic origin and may be based on renewable and/or fossil raw material.

The liquefaction process is typically carried out at elevated temperature, and preferably under non-oxidative conditions. The liquefaction process may be carried out at elevated pressure. Liquefaction processes comprise pyrolysis, hydrothermal liquefaction and others. In a typical pyrolysis process, solid waste plastic is heated to a temperature of 400-600 °C under non-oxidative conditions. The polymers thermally decompose and consequently release vapours and gases that exit the reactor in the gas phase. This vapour/gas stream is subsequently cooled down to condense the (crude) LWP product and to separate the gases. The LWP typically has a boiling range of about 40 °C-550 °C, which corresponds approximately to carbon chain lengths of C5 to C55. Depending on the conversion technology, the final boiling point of the LWP can go up to 750 °C.

The liquefaction process may be carried out in the presence of a catalyst. The effluent from the liquefaction process may be employed as the liquefied waste plastic as such or may be subjected to fractionation (or separation) to provide a fraction (or separated liquid) of the effluent as the liquefied waste plastics. For example, the LWP may be a hydrothermal liquefaction oil or a fraction thereof. Similarly, multiple fractionations may be carried out. In addition, two or more liquefaction process effluents and/or fractions thereof may be combined to give the LWP. These effluents and/or fractions may have the same or similar boiling range or may have different boiling ranges. In this context, fractionation comprises fractional distillation and/or fractional evaporation and/or fractional condensation.

In addition to liquid (NTP) hydrocarbons, i.e. hydrocarbons being liquid at normal temperature and pressure (NTP; 20 °C, 101.325 kPa, as said above, pressure is absolute pressure), typical product effluents from liquefaction processes comprise gaseous (NTP) hydrocarbons, and hydrocarbons that are waxy or solid at NTP but become liquids upon heating, for example upon heating to 80 °C. Crude LWP is a mixture of hydrocarbonaceous organic components with a wide range of carbon chain lengths. Provided the large variations of carbon chain lengths and chemical structures and the properties of the LWP vary depending on the types of plastics (polymers) used in the production of LWP, the type of liquefaction process and conditions of the liquefaction process. Specifically, (crude) LWP is a complex mixture of mainly paraffins, olefins, naphthenes and aromatic hydrocarbons. The total amount of olefins is typically high, from 40 wt. % to 60 wt. %, whereas the amount of aromatic hydrocarbons is typically lower than 20 wt. %. (Crude) LWP also typically contains heteroatoms, including oxygen, nitrogen, chlorine and sulphur, in the form of organic compounds with heteroatom substituents. The amounts of heteroatoms vary depending on the polymers used in production of LWP. Water is usually removed from the LWP product, but some dissolved water may still be present in the LWP.

In the context of the present disclosure, depolymerizing waste plastic means decomposing or degrading the polymer backbones of the waste plastic, typically at least thermally, to the extent yielding polymer and/or oligomer species of smaller molecular weight compared to the starting waste plastic, but still comprising at least liquid (NTP) hydrocarbons. In other words, as used herein, the liquefied waste plastic does not cover plastics in liquid form obtained merely by melting or by dissolving into a solvent, as these do not involve sufficient cleavage of the polymer backbones, nor waste plastics depolymerized completely to the monomer-level and thus being e.g. of gaseous (NTP) form. Depolymerizing waste plastics may also involve cleavage of covalently bound heteroatoms such as O, S, and N from optionally present heteroatom-containing compounds.

Initially the waste plastics, or each waste plastics species in mixed waste plastics, to be subjected to liquefaction, is usually in solid state, typically having a melting point in the range of 100 °C or more as measured by DSC as described by Larsen et al. (“Determining the PE fraction in recycled PP”, Polymer testing, vol. 96, April 2021, 107058). However, the waste plastics, or each waste plastics species, may be at least partially melted before and/or during the depolymerisation.

Solid waste plastics may contain various further components such as additives, reinforcing materials, etc., including fillers, pigments, printing inks, flame retardants, stabilizers, antioxidants, plasticizers, lubricants, labels, metals, paper, cardboard, cellulosic fibres, fibre-glass, even sand or other dirt. Some of the further components may be removed, if so desired, from the solid waste plastics, from melted waste plastic, and/or from liquefied waste plastic using commonly known methods.

Preferably, the (solid) waste plastics (polymer waste) to be subjected to the liquefaction process (depolymerisation), and thus being the base material of the LWP, has an oxygen content of 15 wt.-% or less, preferably 10 wt.-% or less, more preferably 5 wt.-% or less, of the total weight of the (solid) waste plastics. The oxygen content may be 0 wt.-% and may preferably be in the range of 0 wt.-% to 15 wt.-% or 0 wt.-% to 10 wt. %. Oxygen content in wt. % can be determined by difference using the formula 100 wt.-%-(CHN content +ash content), wherein CHN content refers to combined content of carbon, hydrogen and nitrogen, as determined in accordance with ASTM D5291, and ash content refers to ash content as determined in accordance with ASTM D482/EN15403.

The LWP-based feedstock of the present invention is derived from (crude) LWP and may, for example, be LWP (as defined above), crude LWP (i.e. the liquid fraction directly emerging from the liquefaction process), a fraction of LWP or a fraction of crude LWP. In particular the LWP-based feedstock may comprise at least 90 wt.-% (crude) LWP, such as at least 95 wt.-% (crude) LWP or at least 99 wt.-% (crude) LWP. The LWP-based feedstock may particularly be LWP. Specifically, the LWP-based feedstock may be crude LWP. This shall explicitly apply to all embodiments of the present invention.

The LWP-based feedstock preferably comprises primarily hydrocarbons, typically more than 50 wt.-% based on the total weight of the LWP-based feedstock. Typically the LWP-based feedstock comprises two or more hydrocarbon species selected from paraffins, olefins, naphthenes and aromatics. The composition of the LWP-based feedstock may vary depending e.g. on the composition of the waste plastics, liquefaction process type and condition. Further, the assortment of various species of waste plastics and impurities associated with collected waste may result in a presence of impurities including silicon, sulphur, nitrogen, halogens and oxygen related substances in various quantities in the LWP-based feedstock.

Crude LWP may specifically refer to an oil or an oil-like product obtainable from liquefaction using non-oxidative thermal or thermocatalytic depolymerisation of (solid) waste plastics (followed by optional subsequent fractionation). In other words, LWP may also be referred to as “depolymerized polymer waste”, “polymer waste-based oil”, “pyrolysis oil” or “liquefied polymer waste”.

The method of liquefaction is not particularly limited as long as it is a depolymerisation process and one may mention thermal depolymerisation processes, such as pyrolysis (e.g. fast pyrolysis) of waste plastics, or hydrothermal liquefaction of waste plastics.

A moving-catalyst type reactor system, which may also be referred to as a “moving bed reactor system”, is generally known as a reactor system in which the catalytic material flows alongside with the reactants (feed) and is then separated from the exit stream. The separated catalytic material may be recycled, after optional regeneration.

In the present disclosure, when reference is made to a standard, the latest revision available on Jan. 1, 2023 shall be meant, unless stated to the contrary.

In the present invention, hydrotreatment generally refers to catalytic hydrotreatment, i.e. treatment in the presence of hydrogen and a hydrotreatment catalyst. The same applies to hydroprocessing, which is carried out as catalytic hydroprocessing, i.e. in the presence of hydrogen and a hydroprocessing catalyst. In this respect, as commonly known in the present technical field, hydrotreatment is a treatment favouring (full or partial) olefin (or alkyne) saturation whereas hydroprocessing is a process favouring heteroatom removal and/or aromates saturation in addition. Similarly, hydrocracking preferably refers to catalytic hydrocracking, i.e. cracking in the presence of hydrogen and a hydrocracking catalyst.

All of the hydrotreatments stated herein (including the mild hydrotreatment, the hydrotreatment of naphtha fraction obtained from step (c2), polishing hydrotreatment as well as the hydrotreatment reactions occurring in the hydrocracking stage) are performed in the presence of at least one catalyst. The catalyst may, for example, comprise at least one component selected from IUPAC group 6, 8 or 10 of the Periodic Table of Elements. When employing a supported catalyst, the catalyst preferably contains Mo and at least one further transition metal on a support. Examples of such a supported catalyst are a supported NiMo catalyst or a supported CoMo catalyst, or a mixture of both. In a supported catalyst, the support preferably comprises alumina and/or silica. These catalysts are usually employed as sulphided catalysts to ensure that the catalysts are in their active (sulphided) form. Turning the catalysts into their active (sulphided) form may be achieved by sulphiding them in advance (i.e. before starting the hydrotreatment reaction) and/or by adding a sulphur-containing feed (containing sulphur e.g. as an organic or inorganic sulphide). The feed may contain the sulphur from the start, or a sulphur additive may be admixed to the feed. In a preferable embodiment, the hydrotreating employs a catalyst and the catalyst is a supported NiMo catalyst and the support comprises alumina (NiMo/Al₂O₃) and/or the catalyst is a supported CoMo catalyst and the support comprises alumina (CoMo/Al₂O₃).

Moreover, unless specified to the contrary, a (content) percentage (%) mentioned in the present invention relates to % by weight. When reference is made to a pressure value, this pressure value shall refer to an absolute pressure, unless specified to the contrary.

All embodiments (such as all preferred values and/or ranges within the embodiments, even from Examples) of the present invention may be combined with each other to give (preferred) embodiments, unless explicitly specified otherwise or unless such a combination would result in a contradiction. Specifically, it is to be understood that the embodiments of the respective process/method steps recited herein may be combined with each other and with embodiments of other process/method steps. For example, any embodiment of the mild hydrotreatment step may be combined with any embodiment of the hydrocracking step and/or of the optional finishing step, unless indicated to the contrary.

### DETAILED DESCRIPTION OF THE INVENTION

The present invention relates to a method for upgrading liquefied waste plastic (LWP). The method comprises providing a liquefied waste plastic-based feedstock (LWP-based feedstock) (step (a)), subjecting the LWP-based feedstock to mild hydrotreatment in the presence of hydrogen and a hydrogenation catalyst to provide a hydrotreated LWP (step (b)), providing the hydrotreated LWP, after optional blending with a first hydrocarbon feed, as a first hydrocracking feed (deep (c1)), and/or fractionating the hydrotreated LWP to obtain at least a naphtha fraction and a heavy fraction, and providing the heavy fraction, after optional blending with a second hydrocarbon feed, as a second hydrocracking feed (step (c2)), hydrocracking the first hydrocracking feed and/or the second hydrocracking feed in a moving-catalyst type reactor system in the presence of hydrogen and a hydrogenation catalyst to obtain a hydrocracked product (step (d)), and fractionating the hydrocracked product to obtain at least a distillate fraction and a residue fraction (step (e)).

In the method of the present invention, steps (a), (b), (d) and (e) are mandatory steps. Moreover, at least one of steps (c1) and (c2) must be present and both may be present. In other words, the method of the present invention may also be referred to as a method comprising (a) providing a liquefied waste plastic-based feedstock (LWP-based feedstock), (b) subjecting the LWP-based feedstock to mild hydrotreatment in the presence of hydrogen and a hydrogenation catalyst to provide a hydrotreated LWP, (c) providing a hydrocracking feed, (d) hydrocracking the hydrocracking feed in a moving-catalyst type reactor system in the presence of hydrogen and a hydrogenation catalyst to obtain a hydrocracked product, and (e) fractionating the hydrocracked product to obtain at least a distillate fraction and a residue fraction, wherein step (c) of providing a hydrocracking feed comprises (c1) providing the hydrotreated LWP, after optional blending with a first hydrocarbon feed, as the hydrocracking feed (first hydrocracking feed), and/or (c2) fractionating the hydrotreated LWP to obtain at least a naphtha fraction and a heavy fraction, and providing the heavy fraction, after optional blending with a second hydrocarbon feed, as the hydrocracking feed (second hydrocracking feed).

The method of the present invention thus includes two different routes (c1) and (c2) for providing a hydrocracking feed. For both of these routes, however, it is essential that a mild hydrotreatment (b) be carried out in advance. This mild hydrotreatment mainly aims at reducing the amount of highly reactive species, such as diolefins (in the present invention, the term “diolefins” shall refer only to conjugated diolefins) and/or alkynes, in the LWP-based feedstock and thus may also be referred to as a selective hydrotreatment. Reducing the amount of highly reactive species at this early stage of the method is important to avoid upstream problems in general. However, the inventors surprisingly found that in particular the hydrocracking step can benefit from the mild hydrotreatment in terms of improved catalyst life and reduced coking.

The route/step (c1) is a direct hydrocracking route in which the LWP-based feedstock is subjected to hydrocracking, optionally together with a co-feed which is blended with the hydrotreated LWP, in which case the (optionally blended) hydrotreated LWP is referred to as a “first hydrocracking feed”. The route (c1) thus makes maximum use of all components of the LWP-based feedstock for the hydrocracking step, achieving high yield of this step.

In route/step (c2), the hydrotreated LWP is fractionated into at least a naphtha fraction and a heavy fraction (such as a residue/bottom fraction or a heavy distillate fraction). This route (c2) thus allows separating lighter (naphtha range) components from heavier components (in the heavy fraction) and subjecting at least the heavy fraction to hydrocracking, optionally together with a co-feed which is blended with the heavy fraction, in which case the (optionally blended) heavy fraction is referred to as a “second hydrocracking feed”. The lighter (naphtha range) components may then be used as such or may be upgraded using an alternative procedure in accordance with actual need (e.g. depending on market needs). This route (c2) thus gives the flexibility to produce a maximum share of (most) valuable products even under circumstances where the definition of a “valuable product” shifts. Moreover, the inventors surprisingly found that Si-containing impurities (such as organosilicon compounds) tend to be present (in highest amounts) in the naphtha fraction. Since such impurities may be harmful for the catalysts employed in the hydrocracking step (d), this route (c2) thus provides the benefit of further improving catalyst life of the step (d) catalyst.

The method of the present invention may further comprise blending the hydrotreated LWP and/or the heavy fraction, with a (first and/or second) hydrocarbon feed prior to hydrocracking (or in the hydrocracking. The (first and/or second) hydrocarbon feed may also be referred to as “hydrocracking co-feed” or simply “hydrocarbons feed”. The hydrocarbons feed would have a different impurities profile than the LWP-based feedstock being subjected to the mild hydrotreatment (b), since said hydrocarbon feed is preferably of any origins other than LWP thus being “hydrocarbon feed of other origins”.

In one embodiment of the present invention, the hydrocarbons feed is selected from vacuum gas oil (VGO) fraction, gas oil (GO) fraction, heavy gas oil (HGO) fraction, kerosene fraction, light gas oil fraction, atmospheric residue (AR) fraction, vacuum residue (VR) fraction and deasphalted oil (DAO) fraction. Other suitable hydrocarbons feed to be used for blending include a crude oil-derived feedstock comprising at least one crude oil-fraction, or hydrocarbons derived from bio-based fats or bio-based oils or bio-based fatty acids, or lignocellulosic based hydrocarbons, or Fischer Tropsch or other synthetic hydrocarbons.

Blending (in step (c1) and/or step (c2)) may occur before feeding to a hydrocracking reactor system and/or may be accomplished within the hydrocracking reactor system.

In an embodiment, the method comprises at least step (c1). In a further embodiment, the method comprises at least step (c2). In a further embodiment, the method comprises both step (c1) and step (c2).

The method may further comprise splitting up the hydrotreated LWP into at least two volumes and forwarding a first volume to step (c1) and/or a second volume to step (c2).

The first hydrocracking feed and the second hydrocracking feed may both be subjected to step (d) together.

That is, both step (c1) and (c2) may be carried out with parts (volumes or streams) of the hydrotreated LWP in parallel. In this case, hydrocracking in step (d) may be carried out in a hydrocracking reactor system with two independent hydrocracker feeds or the first and second hydrocracking feeds may be combined (co-feed) and processed (together) in a single hydrocracking reactor system. In this respect, the term “single” hydrocracking reactor system refers to the hydrocracking stage as such, which may be accomplished in multiple reactors. In general, in the present invention, when reference is made to a “reactor” or “reactor system” (or a step carried out in a reactor), this shall refer to (a step carried out in) a reactor system (or reactor unit) which comprises at least one reactor of the specified type, and may comprise multiple reactors each being of the specified type. Specific arrangements are well known to the skilled person and can be selected in accordance with circumstances. By employing both routes (c1) and (c2) intermittently or simultaneously, depending on needs, the amount of e.g. naphtha range fraction from step (c2) and/or the distribution of the hydrocracking effluent may be fine-tuned by adjusting the ratio of hydrotreated LWP being processed via route (c1) or via route (c2).

In an embodiment, the first hydrocarbon feed is the same as the second hydrocarbon feed, and (this feed) is blended in the first hydrocracking feed and/or in the second hydrocracking feed.

In particular when first hydrocracking feed and the second hydrocracking feed are subjected to hydrocracking together (in the same hydrocracking reactor system), it is possible and reasonable to employ the same co-feed (first and second hydrocarbon feed). This co-feed may be blended with the hydrotreated LWP, or may be blended with the heavy fraction, or may be blended with both independently, or may be blended with a blend of hydrotreated LWP and heavy fraction (e.g. before feeding to the hydrocracker or feeding the hydrotreated LWP, heavy fraction and the co-feed directly to the hydrocracker). It is also possible to blend multiple (further) hydrocracker feeds before feeding to the hydrocracker and/or as a direct co-feed to the hydrocracker.

The first and/or second hydrocarbon feed is preferably at least one selected from the group consisting of
a crude oil-derived feedstock comprising at least one crude oil-fraction, wherein the crude oil fraction is selected from vacuum gas oil (VGO) fraction, gas oil (GO) fraction, heavy gas oil (HGO) fraction, kerosene fraction, light gas oil fraction, atmospheric residue (AR) fraction, vacuum residue (VR) fraction and deasphalted oil (DAO) fraction,
a crude LWP
a fraction of crude LWP,
a bio-based hydrocarbon feed derived from fat(s) or oil(s) or fatty acid(s), or derivatives of fat(s), oil(s) or fatty acid(s),
lignocellulose-based hydrocarbon(s),
used lubricating oil(s), and
Fischer Tropsch hydrocarbon(s).

The method may further comprise a pre-processing step before step (b). The pre-processing step preferably comprises at least aqueous alkaline heat treatment (HT processing) of the LWP-based feedstock.

The aqueous alkaline heat treatment is a heat treatment of the LWP-based feedstock with an aqueous medium under alkaline (basic) conditions. The alkaline conditions mean a pH of the aqueous solution of more than 7.0, preferably at least 8.0, at least 9.0 or at least 10.0. The alkaline conditions are preferably adjusted by employing an alkaline substance dissolved in the aqueous medium. The content of the alkaline substance is preferably in the range of from 0.2 to 10.0 wt.-%, preferably at least 0.5 wt.-% or at least 1.0 wt.-%.

The aqueous medium is preferably water and may contain further components (in addition to water and alkaline substance) as long as they do not interfere with the HT processing.

The HT processing is preferably carried out at a temperature in the range of 150 °C to 450 °C, more preferably 200 °C to 450 °C. Employing a temperature of 150 °C or above, in particular 200 °C or above is particularly preferable because such a temperature results not only in washing/acid removal but actually results in reactive treatment of the LWP (reactive extraction), thus even reducing/removing impurities such as organic halogen compounds. In other words, such a high temperature results in reaction of impurity compounds which are otherwise insoluble in water and allows removing the impurities (such as organic-bound halogen). Specifically, the present inventors found that reactive extraction using an aqueous solution of a alkali metal/alkaline earth metal hydroxide at 150 °C or more, preferably 200 °C or more removes not only chlorine contaminants and to some degree nitrogen contaminants (both of which are undesired in steam cracker feeds) but furthermore can remove silicon-containing contaminants (such as organic silicon compounds and/or colloidal inorganic silicon material), thus enabling efficient hydrotreatment of pre-purified LWP material. The HT processing may be carried out at a temperature of 150 °C or more, preferably 190 °C or more, 200 °C or more, 210 °C or more, 220 °C or more, 240 °C or more, or 260 °C or more. The HT processing may be carried out at a temperature of 450 °C or less, preferably 400 °C or less, 350 °C or less, 320 °C or less, or 300 °C or less. For example, the HT processing may be carried out at a temperature in the range of 200 °C to 350 °C, preferably 220 °C to 330 °C, 240 °C to 320 °C, or 260 °C to 300 °C. Specifically, the HT processing may be carried out as a reactive extraction, as specified in FI128848B.

The pre-processing may comprise purifying the LWP-based feedstock to produce a purified LWP-based feedstock and then fractionating the purified LWP-based feedstock to produce at least one distillate fraction and a purified residue fraction, and forwarding the purified residue fraction to step (b) as the LWP-based feedstock.

The pre-processing may comprise fractionating the LWP-based feedstock to produce at least one distillate fraction and a residue fraction.

The method of the present invention may further comprise subjecting the naphtha fraction obtained from step (c2) to hydrotreatment. The hydrotreatment of the naphtha fraction may be performed with a fixed bed reactor or a moving-catalyst type reactor.

As said above, the naphtha fraction was surprisingly found to contain most of the Si-containing impurities. The hydrotreatment of the naphtha fraction separated (obtained) in step (c2) is suited to remove these Si-containing impurities or at least to reduce their content and thus provides an Si-depleted naphtha fraction. The Si-depleted naphtha fraction may be used for other purposes as such or may be subjected to further processing. It is preferable in the present invention that the naphtha fraction (more preferably the Si-depleted naphtha fraction) be subjected to steam cracking, optionally together with a steam cracking co-feed. That is, the naphtha fraction was found to provide a favourable product distribution in steam cracking.

Preferably, at least one of a naphtha fraction and a diesel fraction is obtained from fractionating the hydrocracked product in step (e). In a preferred embodiment, at least both a naphtha fraction and a diesel fraction are obtained from fractionating the hydrocracked product in step (e). At least one of a gasoline fraction, a heavy fuel oil fraction, and a jet fuel fraction may further be obtained from fractionating the hydrocracked product in step (e).

The method of the present invention may further comprise a finishing step. The finishing step may comprise subjecting at least a fraction of the hydrocracked product to at least one of an isomerisation step and/or a mild hydrocracking step and/or a polishing hydrotreatment step. The finishing step may specifically comprise subjecting at least a fraction of the hydrocracked product to at least a polishing hydrotreatment step. The polishing hydrotreatment step is carried out at a temperature in the range of from 300 °C to 450 °C. The polishing hydrotreatment step may be carried out at a pressure in the range of from 20 bar to 80 bar, preferably 40-60 bar. The polishing hydrotreatment step may be carried out in a fixed bed reactor.

The finishing step may comprise subjecting at least a fraction of the hydrocracked product to at least a mild hydrocracking step. The mild hydrocracking step is preferably carried out at a temperature in the range of from 300 °C to 500 °C, such as in the range of from 300 °C to 450 °C. The mild hydrocracking step may be carried out at a pressure in the range of from 125 bar to 200 bar. The mild hydrocracking step may be carried out in a fixed bed reactor.

The step (c2) preferably provides a distillate fraction comprising components boiling at 180 °C or above as the heavy fraction.

The total feed to the hydrocracker preferably contains at least 0.5 wt.-%, more preferably at least 1.0 wt.-% or at least 2.0 wt.-% of the hydrotreated LWP. The total feed shall encompass all feeds for conversion (which are mainly hydrocarbons) and shall not encompass catalyst (or carrier) or diluents, such as carrier gas, if present. The total feed to the hydrocracker preferably contains at least 0.5 wt.-%, more preferably at least 1.0 wt.-% or at least 2.0 wt.-% of the heavy fraction. The content (upper limit) of hydrotreated LWP and heavy fractioning the total feed to the hydrocracker is not particularly limited, but is preferably independently selected from 95 wt. % or less, 70 wt.-% or less, or 50 wt.-% or less. As a matter of course, the summed content of the hydrotreated LWP and heavy fraction cannot exceed 100 wt.-%.

The moving-catalyst type reactor system is preferably selected from the group consisting of a moving bed reactor system, a fluidised bed reactor system, an ebullated bed reactor system and a slurry reactor system. When referring the conditions or equipment (e.g. reactor system) of the respective steps of the invention, such description shall refer independently to each individual equipment or condition in case multiple such steps are carried out. For example, the above reactor system types shall independently refer to both hydrocracking reactor systems in case hydrocracking of (blended) hydrotreated LWP is carried out in parallel (in a different reactor system) to hydrocracking of (blended) heavy fraction.

The temperature in hydrocracking step (d) is preferably in the range of from 300 °C to 500 °C, preferably from 300 °C to 450 °C. The pressure in hydrocracking step (d) is preferably in the range of from 125 bar to 200 bar.

The hydrocracking step (d) is preferably carried out in the presence of a heterogeneous catalyst. The catalyst is preferably a supported catalyst. The support preferably comprises alumina and/or silica. The catalyst in the hydrocracking step (d) preferably comprises at least one component selected from IUPAC group 6, 8 or 10 of the Periodic Table of Elements. Specifically, the catalyst is preferably a supported catalyst and comprises at least Mo and at least one further transition metal on a support, such as a supported NiMo catalyst or a supported CoMo catalyst, wherein the support preferably comprises alumina and/or silica. Preferably, the catalyst in the hydrocracking step (d) is a supported CoMo catalyst and the support comprises alumina (CoMo/Al₂O₃) and/or the catalyst is a supported NiMo catalyst and the support comprises alumina (NiMo/Al₂O₃). In particular, the catalyst in the hydrocracking step (d) may be a supported NiMo catalyst and the support comprises alumina (NiMo/Al₂O₃).

These catalysts are preferably employed as sulphided catalysts to ensure that the catalysts are in their active (sulphided) form. Turning the catalysts into their active (sulphided) form may be achieved by sulphiding them in advance (i.e. before starting the hydrotreatment reaction) and/or by adding a sulphur-containing feed (containing sulphur e.g. as an organic or inorganic sulphide). The feed may contain the sulphur from the start, or a sulphur additive may be admixed to the feed.

The mild hydrotreatment (b) is preferably carried out in the presence of a heterogeneous catalyst. The mild hydrotreatment (b) is preferably carried out in a fixed bed reactor system. The mild hydrotreatment (b) is preferably carried out at a temperature in the range of from 100 °C to 350 °C, more preferably 170 °C to 340 °C. The catalyst in the mild hydrotreatment (b) is preferably a supported catalyst. The support preferably comprises alumina and/or silica. The catalyst preferably comprises at least one component selected from IUPAC group 6, 8 or 10 of the Periodic Table of Elements. Preferably, the catalyst is a supported catalyst and comprises at least Mo and at least one further transition metal on a support, such as a supported NiMo catalyst or a supported CoMo catalyst, wherein the support preferably comprises alumina and/or silica. Preferably, the catalyst in the mild hydrotreatment (b) is a supported CoMo catalyst and the support comprises alumina (CoMo/Al₂O₃) and/or the catalyst is a supported NiMo catalyst and the support comprises alumina (NiMo/Al₂O₃). These catalysts are preferably employed as sulphided catalysts to ensure that the catalysts are in their active (sulphided) form. Turning the catalysts into their active (sulphided) form may be achieved by sulphiding them in advance (i.e. before starting the hydrotreatment reaction) and/or by adding a sulphur-containing feed (containing sulphur e.g. as an organic or inorganic sulphide). The feed may contain the sulphur from the start, or a sulphur additive may be admixed to the feed.

The mild hydrotreatment (b) is repeated before forwarding the hydrotreated LWP to step (c1) and/or (c2).

The total fresh feed of the mild hydrotreatment (b) preferably contains at least 50 wt.-% LWP-based feedstock, such as 50-100 wt.-%, or at least 60 wt.-%, at least 70 wt.-%, at least 80 wt.-%, at least 90 wt.-%, at least 95 wt.-%, or at least 99 wt.-% LWP-based feedstock. The remainder of the total fresh feed may be a co-feed or a diluent, preferably a hydrocarbon feed or diluent. It is particularly preferably for the remainder of the total fresh feed to have an impurities pattern which differs from that of LWP. The remainder of the total fresh feed may particularly be at least one of a crude oil-derived feedstock comprising at least one crude oil-fraction, e.g. selected from vacuum gas oil (VGO) fraction, gas oil (GO) fraction, heavy gas oil (HGO) fraction, kerosene fraction, light gas oil fraction, atmospheric residue (AR) fraction, vacuum residue (VR) fraction and deasphalted oil (DAO) fraction, a bio-based hydrocarbon feed derived from fat(s) or oil(s) or fatty acid(s), or derivatives of fat(s), oil(s) or fatty acid(s), lignocellulose-based hydrocarbon(s), used lubricating oil(s), and Fischer Tropsch hydrocarbon(s). The total feed (fresh feed and optional recycle feed) does not include catalyst, hydrogen or carrier gas, if any. The fresh feed to the mild hydrotreatment may particularly be (consist of) LWP, more specifically crude LWP.

Preferably, the mild hydrotreatment (b) is performed under conditions of a H₂ to oil ratio in the range of 200 to 450 Nm³/stdm³, preferably 220 to 400 Nm³/stdm³, a LHSV (liquid hourly space velocity) in the range of 0.1 to 2.0 h⁻¹, preferably 0.2 to 0.5 h⁻¹, and a temperature in the range of 100-350 °C, preferably 170-250 °C. In this context, “oil” means the feed of the mild hydrotreatment (the “feed” excludes H2, catalyst and carrier, if any). Nm³ is normal cubic meters and stdm³ is standard cubic meters (i.e. gas and liquid volume, respectively, converted to standard conditions). LHSV is the flow rate (in kg/h) of mild hydrotreatment feed (oil) divided by weight (in kg) of the catalyst employed in the step.

Hydrogen may be mixed with the LWP-based feedstock before carrying out the mild hydrotreatment (b). This means that mixing is accomplished before the temperature exceeds the reaction temperature (e.g. as indicated above) and/or before the LWP-based feedstock reaches the hydrotreatment catalyst (catalyst bed). A guard bed (e.g. not containing hydrotreatment catalyst) may be provided as well (and may be provided before/upstream or after/downstream mixing hydrogen).

The mild hydrotreatment(b) preferably includes a stage where a part of the hydrotreated LWP formed in the mild hydrotreatment (b) is recycled back to the mild hydrotreatment (b). The amount of recycling, if present, depends among others on the hydrotreatment conditions, the hydrotreatment catalyst and reactor design, such as number of reactors, type of catalyst bed and number of catalyst beds in the reactors.

The content of diolefins in the hydrotreated LWP is preferably 0.30 wt.-% or lower, more preferably 0.25 wt.-% or lower, 0.20 wt.-% or lower, 0.15 wt. % or lower, or 0.10 wt.-% or lower.

As a result of the mild hydrotreatment (b), a hydrotreated LWP is formed. The formed hydrotreated LWP contains lower amounts of impurities, contaminants and harmful components compared to the LWP-based feedstock. With impurities, contaminants and harmful components is herein meant any substance, compound or composition which may have detrimental properties to any component, equipment or catalyst downstream of the hydrotreatment. Especially harmful components are compounds containing hetero atoms, metals and metalloids. Especially harmful hetero atoms include halogens such as chlorine. Especially harmful metals include but are not limited to mercury, lead, sodium, arsenic, vanadium, iron, zinc and aluminium. Compounds containing silicon, phosphorous, oxygen, nitrogen and sulphur can also be problematic downstream the mild hydrotreatment, if not removed. Furthermore, especially conjugated di-olefins (simply referred to as “diolefins” herein) and olefins are considered agents causing coking or fouling which have to be minimised from the LWP in order for the treated LWP to be used downstream as a feedstock for steam cracking for example.

The purpose of the mild hydrotreatment (b) according to the invention is to reduce the risk of harmful and/or detrimental properties of any of the impurities, contaminants and harmful components, which might be present in the LWP. The mild hydrotreating step (b) is suited to reduce the amount of these components and therefore reduces the risks and harms they would otherwise pose on any component, equipment or catalyst downstream of the hydrotreatment. After the mild hydrotreatment (b) in mild hydrotreatment conditions as specified, the conjugated diolefin content in the LWP is preferably below 0.20 wt. %.

The method of present invention provides an upgraded hydrocarbon fraction. The upgraded hydrocarbon fraction may in particular be the distillate fraction (at least one distillate fraction) obtained in step (e), after optional post-treatment.

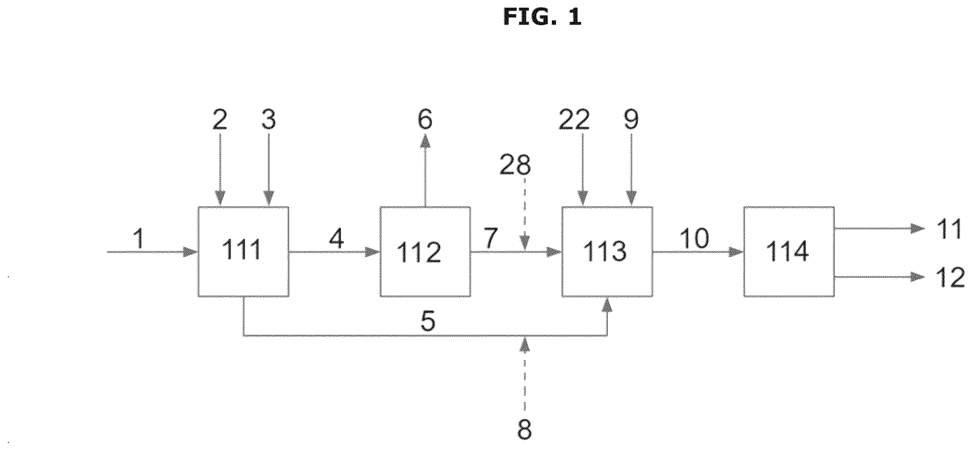

An embodiment of the present invention as illustrated in FIG. 1 provides an efficient method for producing valuable products from LWP depending on needs and thus contributes to sustainability.

### LIST OF FIG. 1 REFERENCE SIGNS

1 LWP-based feedstock
2,22 Hydrogen supply stream
3 Catalyst
4, 5 Product from mild hydrotreatment (hydrotreated LWP)
6 Naphtha fraction
7 Heavy fraction
8 First hydrocarbon feed
28 Second hydrocarbon feed
9 Catalyst
10 Hydrocracked product
11 Distillate fraction
12 Residue fraction
111 Mild hydrotreatment
112 Fractionation
113 Hydrocracking
114 Fractionation

1-15. (canceled)

16. A method for upgrading liquefied waste plastic (LWP), the method comprising:
(a) providing a liquefied waste plastic-based feedstock (LWP-based feedstock);
(b) subjecting the LWP-based feedstock to mild hydrotreatment in the presence of hydrogen and a hydrogenation catalyst to provide a hydrotreated LWP;
(c1) providing the hydrotreated LWP, after optional blending with a first hydrocarbon feed, as a first hydrocracking feed; and/or
(c2) fractionating the hydrotreated LWP to obtain at least a naphtha fraction and a heavy fraction, and providing the heavy fraction, after optional blending with a second hydrocarbon feed, as a second hydrocracking feed;
(d) hydrocracking the first hydrocracking feed and/or the second hydrocracking feed in a moving-catalyst type reactor system in a presence of hydrogen and a hydrogenation catalyst to obtain a hydrocracked product; and
(e) fractionating the hydrocracked product to obtain at least a distillate fraction and a residue fraction.

17. The method according to claim 16, wherein the first hydrocracking feed and the second hydrocracking feed are both subjected to step (d) together.

18. The method according to claim 16, wherein the first and/or second hydrocarbon feed is at least one selected from the group consisting of:
a crude oil-derived feedstock including at least one crude oil-fraction, wherein the crude oil fraction is selected from vacuum gas oil (VGO) fraction, gas oil (GO) fraction, heavy gas oil (HGO) fraction, kerosene fraction, light gas oil fraction, atmospheric residue (AR) fraction, vacuum residue (VR) fraction and deasphalted oil (DAO) fraction;
a crude LWP and/or a fraction thereof;
a bio-based hydrocarbon feed derived from fat(s) or oil(s) or fatty acid(s), or derivatives of fat(s), oil(s) or fatty acid(s);
lignocellulose-based hydrocarbon(s);
used lubricating oil(s); and
Fischer Tropsch hydrocarbon(s).

19. The method according to claim 16, comprising:
subjecting the naphtha fraction obtained from step (c2) to hydrotreatment performed with a fixed bed reactor or a moving-catalyst type reactor.

20. The method according to claim 16, comprising:
obtaining at least a naphtha fraction and a diesel fraction from fractionating the hydrocracked product in step (e).

21. The method according to claim 16, comprising:
a finishing step.

22. The method according to claim 21, wherein the finishing step comprises:
subjecting at least a fraction of the hydrocracked product to at least one of an isomerisation step and/or a mild hydrocracking step and/or a polishing hydrotreatment step.

23. The method according to claim 16, comprising:
a pre-processing step before step (b), wherein the pre-processing step includes at least aqueous alkaline heat treatment (HT processing) of the LWP-based feedstock.

24. The method according to claim 16, comprising:
preforming the hydrocracking in a moving-catalyst type reactor system configured as a moving bed reactor system, a fluidised bed reactor system, an ebullated bed reactor system or a slurry reactor system.

25. The method according to claim 16, wherein a temperature in hydrocracking step (d) is in a range of from 300 °C to 500 °C, and/or from 300 °C to 450 °C.

26. The method according to claim 16, wherein a pressure in hydrocracking step (d) is in a range of from 125 bar to 200 bar.

27. The method according to claim 16, comprising:
carrying out the hydrocracking step (d) in a presence of a heterogeneous catalyst, wherein the hydrogenation catalyst in the hydrocracking step (d) is a supported catalyst.

28. The method according to claim 27, wherein the heterogeneous catalyst is a supported catalyst and comprises:
at least Mo and at least one further transition metal, NiMo or CoMo, on a support, on alumina and/or on silica, the heterogeneous catalyst being an alumina-supported CoMo catalyst (CoMo/Al₂O₃) and/or an alumina-supported NiMo catalyst (NiMo/Al₂O₃).

29. The method according to claim 16, wherein a content of diolefins in the hydrotreated LWP is 0.30 wt.-% or lower, and/or 0.25 wt.-% or lower, 0.20 wt.-% or lower, 0.15 wt.-% or lower, and/or 0.10 wt.-% or lower.

30. The method according to claim 16 wherein the mild hydrotreatment (b) is performed under conditions which include:
a H₂ to oil ratio in a range of 200 to 450Nm³/stdm³, and/or 220 to 400Nm³/stdm³;
a LHSV (liquid hourly space velocity) in a range of 0.1 to 2.0 h⁻¹, and/or 0.2 to 0.5 h⁻¹; and
a temperature in a range of 100-350 °C, and/or 170-250 °C.
